(19) United States
(12) Patent Application Publication
(10) Pub. No.: US 2024/0052216 A1
(43) Pub. Date: Feb. 15, 2024

(54) ADHESIVE TAPE AND ELECTRONIC APPARATUS

(71) Applicant: DIC Corporation, Tokyo (JP)

(72) Inventors: Shota Tanii, Saitama (JP); Yuichi Takeuchi, Saitama (JP)

(73) Assignee: DIC Corporation, Tokyo (JP)

(21) Appl. No.: 18/361,109

(22) Filed: Jul. 28, 2023

(30) Foreign Application Priority Data
Aug. 12, 2022 (JP) 2022-128830

(51) Int. Cl. C09J 153/00

(52) U.S. Cl. CPC C09J 153/00

(57) ABSTRACT

An adhesive tape is used for fixing a member constituting an electronic apparatus and includes an adhesive layer (A) and a base material (B). The adhesive layer (A) contains an adhesive containing a styrene-based block copolymer and an adhesiveness-imparting resin. The adhesive has a Trouton ratio of 3 or more and 90 or less when the adhesive composition is made into a toluene solution having a solid concentration of 25% (w/w) and is subjected to measurement at 35° C.

### BACKGROUND

### 1. Technical Field

One or more embodiments of the present invention relate to an adhesive tape and an electronic apparatus.

### 2. Description of Related Art

To date, adhesive tapes have been favorably used to fix members constituting various products such as electronic apparatuses. Recently, research has been performed on using such adhesive tapes for fixing various members during production of electronic apparatuses, such as cellular phones, smart phones, notebook-type personal computers, and electronic book readers.

Known examples of adhesive tapes usable for fixing the members include a double-faced adhesive tape in which an adhesive layer is formed on both surfaces of a nonwoven fabric base material, wherein the interlayer fracture area percentage of the double-faced adhesive tape is 10% or less and the tensile strength of the double-faced adhesive tape is 20 N/10 mm or more in both the MD direction (longitudinal direction) and the TD direction (transverse direction) (refer to, for example, Japanese Unexamined Patent Application Publication No. 2001-152111).

In this regard, the applications of the adhesive tape are diversified, and the shape of the tape may be required to not change due to the weight of the member itself to be fixed or due to an external impact. In addition, when the tape is held in the state in which the weight of the member itself or external stress is applied to the tape, the shape of the tape may change to relax the stress. As a result, a positional shift of the member to be fixed may occur.

### SUMMARY

One or more embodiments of the present invention provide an adhesive tape having diversified application wherein the shape of the tape does not change when the weight of the member itself or an external impact or continuous stress is applied to the tape, and deformation due to application of the weight of the member itself or an external impact or stress does not readily occur.

The contents of the present disclosure include the following one or more embodiments.
(1) An adhesive tape used for fixing a member constituting an electronic apparatus, including an adhesive layer (A), wherein the adhesive layer (A) contains an adhesive, the adhesive contains a styrene-based block copolymer and an adhesiveness-imparting resin, and an adhesive composition used for producing the adhesive has a Trouton ratio of 3 or more and 90 or less when the adhesive composition is made into a toluene solution having a solid concentration of 25% (w/w) and is subjected to measurement at 35° C.
(2) The adhesive tape according to (1), wherein the adhesive composition used for producing the adhesive has an extensional viscosity of 0.01 Pa·s or more and 40 Pa·s or less when the adhesive composition is made into a toluene solution having a solid concentration of 25% (w/w) and is subjected to measurement at 35° C.
(3) The adhesive tape according to (1) or (2), wherein the adhesive composition used for producing the adhesive has a shear viscosity of 0.01 Pa s or more and 0.4 Pa s or less when the adhesive composition is made into a toluene solution having a solid concentration of 25% (w/w) and is subjected to measurement at 35° C.
(4) The adhesive tape according to any one of (1) to (3), wherein a storage elastic modulus E′ of the adhesive measured using a dynamic viscoelasticity spectrum at 1 Hz and 23° C. is 1×10 4 Pa or more.
(5) The adhesive tape according to any one of (1) to (4), wherein the thickness of the adhesive layer (A) is 5 μm or more and 100 μm or less.
(6) The adhesive tape according to any one of (1) to (5), wherein the adhesive layer (A) has no core base material.
(7) The adhesive tape according to any one of (1) to (6), wherein the styrene-based block copolymer is a hydrogenated styrene-based block copolymer.
(8) The adhesive tape according to any one of (1) to (7), wherein the proportion of the styrene-based block copolymer in the adhesive is 20% to 70% by mass.
(9) The adhesive tape according to any one of (1) to (8), wherein the adhesive tape is used for fixing two or more housings or members constituting an electronic apparatus.
(10) An electronic apparatus having a structure in which one housing or member is bonded to the other housing or member with the adhesive tape according to any one of (1) to (9) interposed therebetween.

One or more embodiments of the present invention can provide an adhesive tape having diversified application and a high modulus of elasticity whose shape does not change due to the weight of the member itself to be fixed or due to an external impact.

### DETAILED DESCRIPTION

### Adhesive Tape

An adhesive tape according to one or more embodiments of the present invention (also referred to as an adhesive tape according to one or more embodiments) includes an adhesive layer (A) and a base material (B). The adhesive layer (A) constituting the adhesive tape according to one or more embodiments contains an adhesive, and the adhesive contains a styrene-based block copolymer and an adhesiveness-imparting resin. An adhesive composition used for producing the adhesive has a Trouton ratio of 3 or more and 90 or less when the adhesive composition is made into a toluene solution having a solid concentration of 25% (w/w) and is subjected to measurement at 35° C. Hereafter, in the present disclosure, “%” when the solid concentration is expressed means “% (weight/weight)”.

The Trouton ratio in one or more embodiments of the present invention is a ratio of the extensional viscosity to the shear viscosity described later and can be measured as described below, for example.

Initially, the adhesive composition used for producing the adhesive is prepared as a toluene solution having a solid concentration of 25%. Herein, “adhesive composition used for producing the adhesive” refers to a composition containing all solid contents in the adhesive at the same ratio as that in the adhesive, and the adhesive and the adhesive composition can differ from each other only in the amount of the solvent and the solvent species. When the adhesive does not contain a solvent, such as water, an organic solvent, or the like, an adhesive composition that is a toluene solution having a solid concentration of 25% by mass can be produced by adding 75 parts by mass of toluene to 25 parts by mass of the adhesive.

In this regard, in one or more embodiments of the present invention, the Trouton ratio of the adhesive composition is measured in an uncross-linked state. Here, “uncross-linked state” denotes a state in which even when the adhesive composition contains a component cross-linkable due to some reaction or external stimulation or even when the adhesive composition contains a cross-linking agent or the like, a cross-linking reaction is intentionally not caused and specifically denotes a state in which heating or application of energy rays to cause cross-linking is not performed.

The adhesive composition toluene solution having a solid concentration of 25% by mass produced as described above is used, the extensional viscosity at an extensional rate of 4,000 s⁻¹ and the shear viscosity at a shear rate of 4,000 s⁻¹ are measured in an atmosphere at 35° C., and the ratio thereof (extensional viscosity/shear viscosity), that is, the Trouton ratio, is determined. There is no particular limitation regarding the methods for measuring the extensional viscosity and the shear viscosity, and, for example, methods and apparatuses explained in the examples described later can be adopted.

Regarding the Trouton ratio of an adhesive composition used for producing the adhesive when the adhesive composition is made into a toluene solution having a solid concentration of 25% and is subjected to measurement at 35° C. in one or more embodiments of the present invention, “toluene solution having a solid concentration of 25%” and “35° C.” are merely experimental conditions when the Trouton ratio is evaluated and are not intended to limit the adhesive tape according to one or more embodiments of the present invention or a method for producing the same. That is, “the Trouton ratio of an adhesive composition used for producing the adhesive when the adhesive composition is made into a toluene solution having a solid concentration of 25% and is subjected to measurement at 35° C.” in one or more embodiments of the present invention represents an intrinsic property of the adhesive contained in the adhesive layer (A) constituting the adhesive tape according to one or more embodiments of the present invention.

### Adhesive Layer (A)

The adhesive layer (A) constituting the adhesive tape according to one or more embodiments may include an adhesive for providing an adhesive composition that is used for producing the adhesive layer (A) and that has a Trouton ratio of 3 or more and 90 or less when the adhesive composition is made into a toluene solution having a solid concentration of 25% and is subjected to measurement at 35° C. The Trouton ratio may be 3 or more and 50 or less or 3 or more and 20 or less. It is preferable that the adhesive having a Trouton ratio of 3 or more and 90 or less be used since the adhesive layer does not undergo plastic deformation even when an excessive impact or stress is applied to the adhesive tape, and, therefore, the adhesive tape, the shape of which does not readily change, can be obtained.

The adhesive layer (A) related to the adhesive tape according to one or more embodiments may include an adhesive for providing an adhesive composition that is used for producing the adhesive layer (A) and that has an extensional viscosity of 0.01 Pa·s or more and 40 Pa·s or less when the adhesive composition is made into a toluene solution having a solid concentration of 25% and is subjected to measurement at 35° C. The extensional viscosity may be 0.02 Pa·s or more and 20 Pa·s or less, 0.1 Pas or more and 10 Pa·s or less, or 0.2 Pa·s or more and 5 Pa·s or less. It is preferable that the adhesive tape include an adhesive for providing an adhesive composition that is used for producing the adhesive layer (A) and that has an extensional viscosity of 0.01 Pa·s or more and 40 Pa·s or less when the adhesive composition is made into a toluene solution having a solid concentration of 25% and is subjected to measurement at 35° C. since the adhesive layer does not undergo plastic deformation even when an excessive impact or stress is applied to the adhesive layer (A), and, therefore, the adhesive layer, the shape of which does not readily change, can be obtained.

The adhesive layer (A) according to one or more embodiments may include an adhesive for providing an adhesive composition that is used for producing the adhesive layer (A) and that has a shear viscosity of 0.01 Pa·s or more and 0.4 Pas or less when the adhesive composition is made into a toluene solution having a solid concentration of 25% and is subjected to measurement at 35° C., and the shear viscosity may be 0.2 Pas or more and 0.4 Pa·s or less or 0.3 Pa·s or more and 0.4 Pas or less. It is preferable that the adhesive tape include an adhesive for providing an adhesive composition that is used for producing the adhesive tape and that has a shear viscosity of 0.01 Pa·s or more and 0.4 Pa·s or less when the adhesive composition is made into a toluene solution having a solid concentration of 25% and is subjected to measurement at 35° C. since the adhesive layer does not undergo plastic deformation even when an excessive impact or stress is applied to the adhesive layer (A), and, therefore, the adhesive layer, the shape of which does not readily change, can be obtained.

The adhesive layer (A) according to one or more embodiments may include an adhesive having a storage elastic modulus E′ measured using a dynamic viscoelasticity spectrum at 1 Hz and 23° C. of 1×10⁴ Pa or more, and the storage elastic modulus E′ may be 5×10⁴ Pa or more and 1×10⁷ Pa or less or 1×10⁵ Pa or more and 1×10⁶ Pa or less. It is preferable that the adhesive tape include an adhesive having a storage elastic modulus E′ measured using a dynamic viscoelasticity spectrum at 1 Hz and 23° C. of 1×10⁴ Pa or more since the shape of the adhesive layer can be suppressed from changing even when an excessive impact or stress is applied to the adhesive layer (A).

Examples of the adhesive tape according to one or more embodiments include adhesive tapes in which a nonwoven fabric base material, a resin film base material, or the like is provided with the adhesive layer (A) on one surface or both surfaces and so-called base-material-less adhesive tapes composed of only the adhesive layer (A) (adhesive tapes in which the adhesive layer (A) has no core base material).

Regarding the adhesive tape according to one or more embodiments, it is preferable that an adhesive tape in which the total thickness of the adhesive layer (A) is 5 μm or more and 100 μm or less be used. The thickness may be 10 μm or more and 90 μm or less or 20 μm or more and 80 μm or less. It is preferable that the adhesive tape in which the total thickness of the adhesive layer (A) is 5 μm or more and 100 μm or less be used since the adhesive layer does not undergo plastic deformation even when an excessive impact or stress is applied to the adhesive tape, and as a result, the adhesive layer, the shape of which does not readily change, can be obtained, and a member constituting an electronic apparatus can be favorably fixed.

Regarding the adhesive tape in which both surfaces of the base material are provided with the adhesive layer (A), the total thickness is the total thickness of the adhesive layers (A), and regarding the base-material-less adhesive tape, the total thickness is the thickness of only the adhesive layer (A) constituting the adhesive tape.

### Styrene-Based Block Copolymer (a)

It is preferable that the adhesive layer (A) according to one or more embodiments be formed using an adhesive containing a hydrogenated styrene-based block copolymer (a).

Regarding the styrene-based block copolymer (a) according to one or more embodiments, so-called ABA-type block copolymers (triblock copolymers), AB-type block copolymers (diblock copolymers), and mixtures of these can be used. A mixture of the triblock copolymer and the diblock copolymer being used as the styrene-based block copolymer (a) enables the adhesive composition used for producing the adhesive to have a Trouton ratio of 3 or more and 90 or less when the adhesive composition is made into a toluene solution having a solid concentration of 25% and is subjected to measurement at 35° C. As a result, the adhesive layer does not undergo plastic deformation even when an excessive impact or stress is applied, the adhesive layer, the shape of which does not readily change, can be obtained, and a member constituting an electronic apparatus can be favorably fixed. It is more preferable that a mixture having the diblock copolymer be used within the range of 10% by mass to 80% by mass relative to the total of the styrene-based block copolymer (a), and use within the range of 15% by mass to 60% by mass is further preferable, use within the range of 15% by mass to 55% by mass is further preferable, and use within the range of 15% by mass to 35% by mass is particularly preferable.

Regarding the styrene-based block copolymer (a) according to one or more embodiments, a styrene-based block copolymer may be used. The styrene-based block copolymer is a triblock copolymer or a diblock copolymer that has a polystyrene unit (al) and a polyolefin unit or is a mixture of a triblock copolymer or a diblock copolymer.

Examples of the polyolefin unit include polybutylene units derived from butadiene and poly(butylene-ethylene) units. It is preferable that the polybutylene unit be adopted since the Trouton ratio of the adhesive composition of the adhesive layer (A) is adjusted to a predetermined range when the adhesive composition is made into a toluene solution having a solid concentration of 25% and is subjected to measurement at 35° C., and, as a result, the adhesive layer does not undergo plastic deformation even when an excessive impact or stress is applied, the adhesive layer, the shape of which does not readily change, can be obtained, and appropriate flexibility required for handling an adhesive tape is realized.

The mass ratio of the polystyrene unit (al) relative to the block copolymer when, for example, a polybutylene unit is adopted as the polyolefin unit may be within the range of 5% by mass to 40% by mass or 10% by mass to 30% by mass, and use within the range of 10% by mass to 25% by mass may be from the viewpoint of obtaining an adhesive tape having excellent wettability with respect to an adherend and excellent adhesive strength.

The polyolefin unit may be within the range of 60% by mass to 95% by mass or the range of 70% by mass to 90% by mass relative to the block copolymer, and use within the range of 75% by mass to 90% by mass is further preferable from the viewpoint of obtaining an adhesive tape having excellent wettability with respect to an adherend and excellent adhesive strength.

Regarding the styrene-based block copolymer (a) according to one or more embodiments, specifically, styrene-based block copolymers, such as styrene-butylene block copolymers and styrene-ethylene-butylene block copolymers, and the like can be used.

Of these, styrene-butylene block copolymers may be used as the styrene-based block copolymer (a) to impart excellent adhesive strength.

Regarding the styrene-based block copolymer (a) according to one or more embodiments, to impart excellent adhesive strength, a block copolymer having a weight average molecular weight within the range of 10,000 to 800,000 may be used, a block copolymer having a weight average molecular weight within the range of 20,000 to 400,000 may be used, and a block copolymer having a weight average molecular weight within the range of 30,000 to 200,000 may be used.

### Adhesiveness-Imparting Resin (b)

Regarding the adhesive usable for forming the adhesive layer (A) according to one or more embodiments, it is preferable that an adhesive containing an adhesiveness-imparting resin (b) be used in addition to the styrene-based block copolymer (a).

Regarding the adhesiveness-imparting resin (b), for example, rosin-based adhesiveness-imparting resins, polymerized-rosin-based adhesiveness-imparting resins, polymerized-rosin-ester-based adhesiveness-imparting resins, rosin-phenol-based adhesiveness-imparting resins, hydrogenated-rosin-ester-based adhesiveness-imparting resins, disproportionated-rosin-ester-based adhesiveness-imparting resins, terpene-based adhesiveness-imparting resins, terpene-phenol-based adhesiveness-imparting resins, aliphatic (petroleum-resin-based) adhesiveness-imparting resins, and C9-petroleum-based adhesiveness-imparting resins can be used.

Of these, C9-petroleum-based adhesiveness-imparting resins may be used as the adhesiveness-imparting resin (b) from the viewpoint of improving wettability with respect to an adherend.

Regarding the C9 petroleum resin, a resin produced by polymerizing the residue resulting from extraction separation of isoprene and cyclopentadiene from a C5 fraction commonly obtained by naphtha cracking can be used. To impart excellent adhesive strength, the adhesiveness-imparting resin may be used within the range of 50 parts by mass to 400 parts by mass relative to 100 parts by mass of the styrene-based block copolymer (a) and may be used within the range of 90 parts by mass to 200 parts by mass.

In this regard, adhesiveness-imparting resins that are liquid at room temperature can also be used as the adhesiveness-imparting resin (b), in addition to the above. Examples of the liquid adhesiveness-imparting resin include process oils, polyester-based adhesiveness-imparting resins, and liquid low-molecular-weight rubber such as polybutenes.

To further improve wettability with respect to an adherend, it is preferable that the liquid adhesiveness-imparting resin (b) be used within the range of 3% by mass to 30% by mass relative to the total amount of the adhesiveness-imparting resin.

### Additive (c)

The adhesive can include, in addition to the above, an additive (c) containing an infrared absorbent, an antioxidant, an ultraviolet absorbent, a filler, glass or plastic fiber, a filler such as a balloon filler, beads, or a metal powder, a pigment, a thickener, a cross-linking agent, and the like, as the situation demands.

In particular, the infrared absorbent can be favorably used when a member constituting a portable electronic apparatus is bonded by applying active energy rays, laser beams, or the like to the adhesive tape according to one or more embodiments of the present invention so as to locally heat the adhesive tape.

### Base Material

Examples of the base material usable as the base material constituting the adhesive tape according to one or more embodiments include porous base materials, such as nonwoven fabrics, cloths, and paper and resin base materials, such as plastic films, polyester films, polyethylene films, polypropylene films, and polyvinyl chloride films.

To improve the anchoring effect of the adhesive layer, the resin base material subjected to corona treatment or anchor coating treatment can be used.

The base material according to one or more embodiments having a thickness of 5 μm or more and 150 μm or less may be used. To exert an effect of imparting excellent tape workability and excellent followability to an adherend, the base material having a thickness of 25 μm to 75 μm may be used.

### Light-Blocking Layer or Reflection Layer

The adhesive tape according to one or more embodiments may include, for example, a light-blocking layer for enhancing the light-blocking effect and a reflection layer for improving reflectivity with respect to visible light and the like.

### Method for Producing Adhesive Tape

The adhesive tape according to one or more embodiments can be produced by, for example, coating one surface or both surfaces of the base material with a composition containing the adhesive by using a roll coater or a die coater, performing drying, and, as the situation demands, causing cross-linking. The composition contains the adhesive according to one or more embodiments and a solvent. The solvent being contained facilitates coating of the base material with the adhesive. There is no particular limitation regarding the solvent, and it is preferable that the solvent vaporizable in a drying step after the base material is coated be used. Examples of such a solvent include organic solvents such as toluene. In this regard, the Trouton ratio is measured by using a 25% toluene solution. However, the solvent during production of the adhesive tape is not limited to toluene, and the concentration thereof is not limited to 25%.

Alternatively, the adhesive tape can also be produced by a transfer method in which an adhesive layer is formed by coating the surface of a mold-releasing liner with the adhesive by using a roll coater or the like in advance, performing drying, and, as the situation demands, causing cross-linking, and the resulting adhesive layer is bonded to one surface or both surfaces of the base material.
In this regard, the base-material-less adhesive tape can also be produced by coating the surface of a mold-releasing liner with the adhesive by using a roll coater or the like in advance, performing drying, and, as the situation demands, causing cross-linking.

### Use of Adhesive Tape

The adhesive tape according to one or more embodiments is exclusively used for fixing a member constituting an electronic apparatus. Examples of the member include two or more housings or lens members constituting the apparatus.

Examples of the electronic apparatus include an electronic apparatus having a structure in which one housing or member serving as the above-described member is bonded to the other housing or member with the adhesive tape interposed therebetween.

Examples of the method for fixing the member include a method in which one housing or display, substrate, sensor member, or lens member and the other housing or display, substrate, sensor member, or lens member are stacked with the adhesive tape interposed therebetween and, thereafter, curing is performed for a predetermined period of time.

### Examples

One or more embodiments of the present invention will be described below in more detail with reference to the examples, but one or more embodiments of the present invention are not limited to these.

Specific explanations will be provided below with reference to examples.

### Used Raw Material

Styrene-based block copolymer (a): weight average molecular weight: 190,000, hydrogenated polystyrene-polyethylene-polyisoprene-polystyrene block copolymer (SEPS) The mass ratio of the polystyrene unit in the total polystyrene-polyethylene-polyisoprene-polystyrene block copolymer was 12% by mass, the mass ratio of the polyethylene unit was 33% by mass, and the mass ratio of the polyisoprene unit was 55% by mass.

Styrene-based block copolymer (b): weight average molecular weight: 35,000, hydrogenated polystyrene-polyethylene-polyisoprene-polystyrene block copolymer (SEPS) The mass ratio of the polystyrene unit in the total polystyrene-polyethylene-polyisoprene-polystyrene block copolymer was 12% by mass, the mass ratio of the polyethylene unit was 33% by mass, and the mass ratio of the polyisoprene unit was 55% by mass.

C9-petroleum-based adhesiveness-imparting resin: aliphatic/aromatic hydrocarbon resin produced by polymerizing styrene, vinyltoluene, indene, piperylene, and the like, which were main components, and oligomer having a softening point of 120° C. and a Mw of 1,000 to 2,000

Isocyanate-based cross-linking agent (solid concentration of 40%): “Coronate L-45” produced by NIPPON POLYURETHANE INDUSTRY CO., LTD.

### Synthesis Example

### Preparation of Acrylic Copolymer Solution

An acrylic copolymer solution having a weight average molecular weight of 500,000 was obtained by dissolving 80 parts by mass of butyl acrylate, 16 parts by mass of methyl methacrylate, 4 parts by mass of acrylic acid, 0.1 parts by mass of 2-dimethylaminoethyl acrylate, and 0.1 parts by mass of 2,2′-azobis(isobutyronitrile) serving as a polymerization initiator in 100 parts by mass of toluene in a reaction container provided with an agitator, a reflux condenser, a thermometer, a dropping funnel, and a nitrogen gas inlet and performing polymerization at 70° C. for 10 hours.

### Example 1

### Preparation of Adhesive Composition

An adhesive composition having a solid content of 25% by mass was obtained by dissolving a mixture of 20 parts by mass of styrene-based block copolymer (a), 30 parts by mass of styrene-based block copolymer (b), and 50 parts by mass of C9-petroleum-based adhesiveness-imparting resin in 300 parts by mass of toluene.

### Production of Adhesive Tape

An adhesive layer was formed by coating the surface of a mold-releasing liner having a thickness of 50 μm with the above-described adhesive composition by using an applicator and performing drying at 85° C. for 5 min so that the thickness after drying was set to be 50 μm. An adhesive tape was produced by bonding the adhesive layer to a mold-releasing liner having a thickness of 38 μm.

### Example 2

### Production of Adhesive Composition

An adhesive composition was prepared in the method akin to that of Example 1 except that 12 parts by mass of styrene-based block copolymer (a), 18 parts by mass of styrene-based block copolymer (b), and 70 parts by mass of C9-petroleum-based adhesiveness-imparting resin were used.

### Production of Adhesive Tape

An adhesive tape was produced in the method akin to that of Example 1 except that the above-described adhesive composition was used.

### Comparative Example 1

### Preparation of Adhesive Composition

An adhesive composition having a solid content of 25% by mass was obtained by adding 30 parts by mass of polymerized-rosin-ester-based adhesiveness-imparting resin (softening point of 125° C. and number average molecular weight of 880) to the acrylic copolymer solution that contained 100 parts by mass of acrylic copolymer as a solid content and that was obtained in the synthesis example and performing mixing for 15 min after toluene was added.

### Production of Adhesive Tape

An adhesive tape was produced in the method akin to that of Example 1 except that the above-described adhesive composition was used.

### Comparative Example 2

### Preparation of Adhesive Composition

An adhesive composition having a solid content of 25% by mass was obtained in the method akin to that of Comparative example 1 except that 1.2 parts by mass of isocyanate-based cross-linking agent (solid concentration of 40%) was added.

### Production of Adhesive Tape

A dried adhesive layer was formed by coating the surface of a mold-releasing liner having a thickness of 50 μm with the above-described adhesive composition by using an applicator and performing drying at 85° C. for 5 min so that the thickness after heat curing was set to be 50 μm. An adhesive tape was produced by bonding the adhesive layer to a mold-releasing liner having a thickness of 38 μm and performing heat curing at 40° C. for 48 hours.

### Evaluation Method

### Extensional Viscosity, Shear Viscosity, and Trouton Ratio

The extensional viscosity at an extensional rate of 4,000 s⁻¹ and the shear viscosity at a shear rate of 4,000 s⁻¹ of the adhesive composition of each of Examples 1 and 2 and Comparative examples 1 and 2 presented in Table were measured by the methods described below, and the Trouton ratio, that is, the ratio thereof (extensional viscosity/shear viscosity), was determined.

The extensional viscosity was measured in conformity with the capillary rheometer evaluation method described in JIS 7199 (ISO 11443, ASTM D 3835).

Specifically, a twin-capillary-type apparatus (RHEOGRAPH 20 produced by Gottfert) was used. A combination of a capillary die having a length of 30 mm and a diameter of 0.3 mm and a capillary die having a length of 0.25 mm and a diameter of 0.3 mm, or a combination of a capillary die having a length of 10 mm and a diameter of 0.5 mm and a capillary die having a length of 0.25 mm and a diameter of 0.5 mm, was used.

Subsequently, true shear viscosity was obtained by removing pressure loss from the apparent shear viscosity (pressure) measured at a temperature of 35° C. and a shear rate of 1,000 to 300,000 s⁻¹ on the basis of Bagley correction. The extensional rate and the extensional viscosity corresponding thereto were determined from the resulting true shear viscosity and the pressure loss by using Cogswell's formula.

The values of the extensional viscosity at an extensional rate of 4,000 s⁻¹, the shear viscosity at a shear rate of 4,000 s⁻¹, and the Trouton ratio are presented in Table.

### Storage Elastic Modulus of Adhesive Layer

An adhesive layer having a thickness of 50 μm was formed by coating the surface of a mold-releasing liner with the adhesive composition used for producing the adhesive tape of each of Examples 1 and 2 and Comparative example 1 by using an applicator and performing drying at 85° C. for 5 min so that the thickness after drying was set to be 50 μm. A dried adhesive layer was formed by coating the surface of a mold-releasing liner with the adhesive composition used for producing the adhesive tape of Comparative example 2 by using an applicator and performing drying at 85° C. for 5 min so that the thickness after heat curing was set to be 50 μm. An adhesive layer having a thickness of 50 μm was formed by bonding the adhesive layer to a mold-releasing liner having a thickness of 38 μm and performing heat curing at 40° C. for 48 hours.

Subsequently, a plurality of the adhesive layers were formed and stacked so as to form a specimen composed of the adhesive layer having a thickness of 2 mm.

Parallel plates having a diameter of 7.9 mm were mounted on a viscoelasticity testing machine (Ares 2kSTD) produced by TA Instruments. The specimen was pinched between the parallel plates with a compression load of 40 to 60 g, and the storage elastic modulus (Pa) at 23° C. was measured under the condition of 1 Hz. The results are presented in Table.

### Shear Adhesive Strength (Maximum Strength)

The adhesive tapes of the examples and the comparative examples were cut into 10 mm×10 mm pieces so as to serve as test samples.

Two aluminum plates 15 mm wide×70 mm long×0.5 mm thick having a smooth surface were subjected to degreasing treatment. One surface of a test sample was peeled off a mold-releasing liner and stacked on one of the aluminum plates, and the sample was pressure-bonded to the upper surface of the one aluminum plate by using a 2-kg hand roller at 23° C.
Subsequently, the mold-releasing liner of the test sample pressure-bonded to the aluminum plate was peeled off. The other aluminum plate having a smooth surface subjected to degreasing treatment was stacked on the upper surface of the test sample, and pressure bonding was performed with a load of 0.5 MPa for 10 sec at 23° C. After being left to stand in an environment at 23° C. for 60 min, the end portion of each of the two aluminum plates was chucked, and the maximum value of the adhesive strength in a tensile test at 100 ram/min in the 180-degree direction was measured by using a TENSILON tensile testing machine (Model: RTM-100 produced by A&D Company, Limited). The results are presented in Table.
Adhesive Layer Tensile Strength (1) (Strength Immediately after Test)

An adhesive layer having a thickness of 50 μm was formed by coating the surface of a mold-releasing liner with the adhesive composition used for producing the adhesive tape of each of Examples 1 and 2 and Comparative example 1 by using an applicator and performing drying at 85° C. for 5 min so that the thickness after drying was set to be 50 μm. A dried adhesive layer was formed by coating the surface of a mold-releasing liner with the adhesive composition used for producing the adhesive tape of Comparative example 2 by using an applicator and performing drying at 85° C. for 5 min so that the thickness after heat curing was set to be 50 μm. An adhesive layer having a thickness of 50 μm was formed by bonding the adhesive layer to a mold-releasing liner having a thickness of 38 μm and performing heat curing at 40° C. for 48 hours.

Subsequently, the adhesive layer was cut into 20 mm wide×60 mm long pieces. Each 10-mm end portion of the cut sample was chucked so that the distance between grips (reference lines) was set to be 40 mm, and the tensile strength (strength immediately after test) when the displacement reached 50 mm in a tensile test at 100 ram/min was measured by using a TENSILON tensile testing machine (Model: RTM-100 produced by A&D Company, Limited).
The results are presented in Table.
Adhesive Layer Tensile Strength (2) (Strength after being Left to Stand)

A tensile test was performed at 100 ram/min in the method akin to that of “Adhesive layer tensile strength (1) (strength immediately after test)” above, and pulling of the adhesive layer was stopped immediately after the displacement reached 50 mm. The state of the displacement being 50 mm was kept for 5 min, and the adhesive layer tensile strength (strength after being left to stand) was measured after a lapse of 10 min. The results are presented in Table.

Stress Residual Rate after Tensile Test (Difficulty of Deforming Adhesive Layer)

The stress residual rate was calculated from the results of “Adhesive layer tensile strength (1) (strength immediately after test)” above and “Adhesive layer tensile strength (2) (strength after being left to stand)” above by using the following formula.

stress residual rate (%)=(tensile strength obtained in “Adhesive layer tensile strength (2) (strength after being left to stand)”)/(tensile strength obtained in “Adhesive layer tensile strength (1) (strength immediately after test)”)×100

The results are presented in Table.

TABLE

| | | Example | Example | Comparative | Comparative |
|---|---|---|---|---|---|
| | | 1 | 2 | example 1 | example 2 |
| Adhesive | Rubber-based block copolymer (a) | 20 | 12 | | |
| composition | (parts by mass) | | | | |
| | Rubber-based block copolymer (b) | 30 | 18 | | |
| | (parts by mass) | | | | |
| | C9-petroleum-based adhesiveness- | 50 | 70 | | |
| | imparting resin (parts by mass) | | | | |
| | Acrylic polymer | | | 100 | 100 |
| | (parts by mass) | | | | |
| | Isocyanate cross-linking agent^{*1} | | | | 1.2 |
| | (parts by mass) | | | | |
| | Solvent (toluene) | 300 | 300 | 300 | 300 |
| | (parts by mass) | | | | |
| | Solid concentration | 25 | 25 | 25 | 25 |
| | (% by mass) | | | | |
| | Extension viscosity (Pa · s) (rate | 0.8 | 0.2 | 47.7 | 42.9 |
| | of about 4,000 (1/s)) | | | | |
| | Shear viscosity (Pa · s) (rate of | 0.3 | 0.1 | 0.5 | 0.5 |
| | about 4,000 (1/s)) | | | | |
| | Trouton ratio (−) | 3 | 3 | 93 | 91 |
| Adhesive tape | Adhesive layer thickness (μm) | 50 | 50 | 50 | 50 |
| (adhesive layer) | Adhesive storage elastic modulus | 354,899 | 177,450 | 247,525 | 271,525 |
| | (Pa) | | | | |
| | Shear adhesive strength (N/cm²) | 130 | 70 | 170 | 165 |
| | Adhesive layer tensile strength (1) | 0.52 | 0.43 | 0.21 | 0.2 |
| | (N/mm²) | | | | |
| | Adhesive layer tensile strength (2) | 0.37 | 0.29 | 0.08 | 0.07 |
| | (N/mm²) | | | | |
| | Stress residual rate after tensile test | 71 | 67 | 38 | 35 |
| | (%) | | | | |

^{*1}solid concentration of 40%

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

What is claimed is:

1. An adhesive tape for fixing a member constituting an electronic apparatus, comprising:
an adhesive layer (A); and
an adhesive composition for producing an adhesive,
wherein the adhesive layer (A) contains the adhesive,
wherein the adhesive contains a styrene-based block copolymer and an adhesiveness-imparting resin, and
wherein the adhesive composition has a Trouton ratio of 3 or more and 90 or less when the adhesive composition is made into a toluene solution having a solid concentration of 25% (w/w) and is subjected to measurement at 35° C.

2. The adhesive tape according to claim 1, wherein the adhesive composition for producing the adhesive has an extensional viscosity of 0.01 Pa·s or more and 40 Pa·s or less when the adhesive composition is made into the toluene solution having the solid concentration of 25% (w/w) and is subjected to measurement at 35° C.

3. The adhesive tape according to claim 1, wherein the adhesive composition for producing the adhesive has a shear viscosity of 0.01 Pa·s or more and 0.4 Pa·s or less when the adhesive composition is made into the toluene solution having the solid concentration of 25% (w/w) and is subjected to measurement at 35° C.

4. The adhesive tape according to claim 1, wherein a storage elastic modulus E′ of the adhesive measured with a dynamic viscoelasticity spectrum at 1 Hz and 23° C. is 1×10⁴ Pa or more.

5. The adhesive tape according to claim 1, wherein a thickness of the adhesive layer (A) is 5 μm or more and 100 μm or less.

6. The adhesive tape according to claim 1, wherein the adhesive layer (A) has no core base material.

7. The adhesive tape according to claim 1, wherein the styrene-based block copolymer is a hydrogenated styrene-based block copolymer.

8. The adhesive tape according to claim 1, wherein a proportion of the styrene-based block copolymer in the adhesive is 20% to 70% by mass.

9. An electronic apparatus comprising a structure in which one housing or member is bonded to other housing or member with the adhesive tape according to claim 1 interposed therebetween.
